(19) United States
(12) Patent Application Publication
(10) Pub. No.: US 2021/0082064 A1
(43) Pub. Date: Mar. 18, 2021

(54) SYSTEMS AND METHODS FOR MONITORING AND MANAGING FACILITIES IN REAL-TIME

(71) Applicant: BUILDING MANAGEMENT SYSTEMS AUSTRALIA PTY LTD, Burwood East (AU)

(72) Inventors: Stephen Briffa, Burwood East (AU); Tina Di Camillo, Burwood East (AU)

(21) Appl. No.: 17/023,557

(22) Filed: Sep. 17, 2020

(30) Foreign Application Priority Data
Sep. 17, 2019 (AU) 2019903449

(51) Int. Cl. G06Q 50/16; G06Q 10/00; G06Q 10/02; G06Q 20/16; G05B 19/042; H04N 7/18; G06K 9/00; G08B 5/22

(52) U.S. Cl. CPC G06Q 50/163; G06Q 10/20; G06Q 10/02; G06Q 20/16; G10L 15/22; H04N 7/181; G06K 9/00771; G08B 5/22; G05B 2219/25011; G05B 19/042

(57) ABSTRACT

Embodiments of the present disclosure provide a centralised facility management systems and methods to monitor and manage a plurality of buildings. A centralised facility management system is capable of monitoring and managing any building anywhere in the world. The system receives real-time audio/visual feed from a number of imaging devices, such as cameras, strategically located in and around a facility. The system is configured to provide immediate feedback, appropriate response and recording of any incident. The system may assist with monitoring people, deliveries, short stay rental guests, move in/outs, mail rooms, lockers, trade personnel, public areas, car parking, and so forth. The system may also include a touch enabled device or a kiosk to provide direct visual access to the system.

### TECHNICAL FIELD

The presently disclosed subject matter generally relates to the field of facility management. Particularly, the present subject matter relates to centralised systems and methods for monitoring and managing a plurality of facilities, such as buildings and equipment, in real-time.

### BACKGROUND

Any references to methods, apparatus or documents of the prior art are not to be taken as constituting any evidence or admission that they formed, or form part of the common general knowledge.

Recently, there had been an increase in short stay rentals, newly constructed facilities or buildings, gated communities, hospitals, community centres, commercial estates, total listings of apartments, and homes available for rent and sale. A significant challenge is the rapid growth of the owner's corporation (OC) industry due to an apartment boom. The managing of a strata and a facility/building involves many tasks like monitoring and managing assets and essential services of the facility/building, facility/building works, cleaning, maintenance, security, catering services, facilities administration, workplace management, risk management, concierge services, property services, and maintaining manuals, rules, records of the facilities, records of meetings, information about customers or clients, visitors, suppliers, commuters, and so forth. There are many challenges that are faced by strata/facility or building managers while managing facilities like buildings. For example, timely communication between stakeholders like tenants, landlords, tradespersons, courier delivery person, guests, and so forth. Other challenges may include keeping track of asset management records, providing concierge services, handling faults, managing and recording changes, information retrieval, dealing with abusive owners and tenants, and so forth. Many administrative tasks are also required for managing a facility that may be time consuming and may require deployment of human resources like building managers at the facility or building. Further, there is a demand from small to medium-sized buildings for a 24-hour concierge and security service, but an onsite concierge was cost prohibitive.

Further, due to security and other issues related with short stay rentals, the strata community/managers have been resistant to short stay rentals or guests like bed and breakfast guests. However recent legal rulings have cemented the reality that short stay rentals in strata buildings are here to stay. The issues relating to short stay rentals may include: security and safety, and quality of life as residents fear an increase in noise and bad behaviour by the short stay guests; amenities issues including untidiness of common areas and overuse of amenities; property damage and theft; building access; and the risk in key copying and keypad issues. Emerging technologies and industry data, including client feedback and demand, have revealed that there is a gap in the market and there is a requirement for improved techniques for managing buildings to overcome these issues.

In light of the above, it's evident that technology has not yet carried over into facilities and buildings management situations and current facilities and buildings management techniques are empirical and limited. Moreover, sudden increase in short-stay rentals listings, homes available for renting, multi-listings, total listings, and the like are limiting factors in facilities or buildings management.

It is an object of the present disclosure to overcome or ameliorate the above discussed disadvantages of the prior art, or at least offer a useful alternative.

### SUMMARY

The present disclosure provides a centralised facility monitoring and management system (hereinafter, may also be referred as a system or management system) to monitor and manage a plurality of buildings. The system is capable of monitoring and managing any building anywhere in the world. The system receives real-time audio/visual feed from a number of imaging devices like cameras strategically located in and around a facility. The system is configured to provide immediate feedback, appropriate response and recording of any incident. The system is configured to assist with monitoring people, deliveries, short stay rental guests, move in/outs, mail rooms, lockers, trade personnel, public areas, car parking, and so forth. The system may also include a touch enabled device or a kiosk to provide direct visual access to the system.

An embodiment of the present disclosure provides a centralised facility management system for monitoring and managing a plurality of facilities in real-time. The centralised facility management system includes an audio/visual input module configured to continuously receive a real-time audio/visual feed of the plurality of facilities from a plurality of imaging devices of the plurality of facilities. The audio/visual input module may include a touch enabled device to enable a concierge user to interact with the centralised facility management system. Further, the centralised facility management system includes a security module. Based on the real-time audio/visual feed, the security module provides a controlled access of a plurality of doors, lockers, parking within and around the plurality of facilities to a plurality of users and vehicles based on the real-time audio/visual feed and at least one of voice recognition, facial recognition, and a wireless technology comprising Bluetooth. The security module is also configured to track an entry and exit of the plurality of users and the vehicles into and out of the plurality of facilities in real-time. The security module also registers and authenticates vehicles based on recognition of vehicle information comprising a number plate. The security module also records and responds to an incident comprising a security incident. Further, the centralised facility management system includes an asset managing module configured to monitor and record a performance of a plurality of assets of each the plurality of facilities in real-time. Further, the centralised facility management system includes a request and booking module configured to enable the plurality of users and other users to raise one or more maintenance requests and booking requests for one or more services and a unit of the plurality of facilities. Further, the centralised facility management system includes a pre-settlement module configured to enable a plurality of facility developers to post progress reports, settlement information, owners corporation information comprising move-in rules, and inductions. Furthermore, the centralised facility management system includes an information display module configured to display information on a display device installed at each of the plurality of facilities. Further, the centralised facility management system includes a communication module configured to automatically send at least one of a communication message and a recorded information to at least one of a plurality of stakeholders and the plurality of users based on the recorded incident, the one or more maintenance requests, the booking requests, the displayed information, and one or more events.

According to another aspect of the present disclosure, the communication module is configured to send at least one of a message and a recorded information to a security official when the security incident is recorded.

According to another aspect of the present disclosure, the centralised facility management system also includes a storage module configured to store and maintain facility information, rules, procedures, information of the plurality of stakeholders, information of the plurality of users, booking information, a plurality of maintenance records, the booking requests, the maintenance requests, asset information, security officials' information, a plurality of facility/building plans, asset locations, ongoing maintenance/construction work information, activities information, the information about facilities' issues, and the audio/visual feed of the plurality of facilities.

According to another aspect of the present disclosure, the pre-settlement module is further configured to enable entering of the final inspection details and tracking defect reporting so as to make pre-settlement inspections easy for the facility developers, banks, property valuers, and purchasers.

According to another aspect of the present disclosure, the one or modules of the centralised facility management system are present in a cloud-based network.

According to another aspect of the present disclosure, the plurality of stakeholders, the plurality of users, and the concierge user accesses the centralised facility management system via at least one of a user interface and a uniform resource locator on a browsing application on an associated computing device.

According to another aspect of the present disclosure, the centralised facility management system includes a data analysing module configured to analyse data comprising at least one of visitors' data, facilities' data, vehicles' data, and people profiles' data. The people profiles' data may include residents' data of the tenants, landlords, short stay rentals guests, and so forth. Further, the data analysing module is configured to take at least one action and learn based on the analysis. The data analysing module may analyse the data to optimize the centralised facility management system and for self-learning purposes. In some embodiments, the data may be analysed using various artificial intelligence (AI) based techniques and data analytics methods.

According to yet another aspect of the present disclosure, the system also includes a payment module for processing and automating a plurality of payments.

According to another embodiment of the present disclosure, the system includes a voice processing module in communication with the payment module configured to enable the plurality of users and the plurality of stakeholders to: provide at least one voice command for making one or more payments, wherein the payment module processes the one or more payments based on the at least one voice command; and ask one or more questions related to at least one of the plurality of facilities and the one or more payments via one or more voice questions.

Another embodiment of the present disclosure provides a method for managing a plurality of monitoring and managing a plurality of facilities in real-time. The method includes continuously receiving, by an audio/visual input module, a real-time audio/visual feed of the plurality of facilities from a plurality of imaging devices of the plurality of facilities. The audio/visual input module includes a touch enabled device to enable a concierge user to interact with the centralised facility management system. The method also includes providing, by a security module, a controlled access of a plurality of doors, lockers, parking within and around the plurality of facilities to a plurality of users and vehicles based on the real-time audio/visual feed and via at least one of voice recognition, facial recognition, and a wireless technology comprising Bluetooth. The method further includes registering and authenticating, by the security module, the vehicles based on recognition of vehicle information comprising a number plate of the vehicles. The method also includes tracking, by the security module, an entry and exit of the plurality of users and the vehicles into and out of the plurality of facilities in real-time. The method also includes recording and responding, by the security module, to an incident comprising a security incident. The method also includes monitoring and recording, by an asset managing module, a performance of a plurality of assets of the plurality of facilities in real-time. The method also includes enabling, by a request and booking module, the plurality of users and other users to raise one or more maintenance requests and booking requests for one or more services and a unit of the plurality of facilities. The method also includes enabling, by a pre-settlement module, a plurality of facility developers to post progress reports, settlement information, owners corporation information comprising move-in rules, and inductions. The method also includes displaying, by an information display module, information on a display device installed at each of the plurality of facilities. The method also includes automatically sending, by a communication module, at least one of a communication message and recorded information to at least one of a plurality of stakeholders and the plurality of users based on the recorded incident, the one or more maintenance requests, the booking requests, the displayed information, and one or more events.

According to an aspect of the present disclosure, the method also includes sending, by the communication module, at least one of a message and a recorded information to a security official when the security incident is recorded.

According to another aspect of the present disclosure, the method also includes storing and maintaining, in a storage module, facility information, rules, procedures, information of the plurality of stakeholders, information of the plurality of users, booking information, a plurality of maintenance records, the booking requests, the maintenance requests, asset information, security officials' information, a plurality of facility/building plans, asset locations, ongoing maintenance/construction work information, the information about facilities' issues, and the audio/visual feed of the plurality of facilities.

According to another aspect of the present disclosure, the method also includes enabling, by the pre-settlement module entering of the final inspection details and tracking defect reporting so as to make pre-settlement inspections easy for the facility developers, banks, property valuers, and purchasers.

According to another aspect of the present disclosure, the method also includes accessing the centralised facility management system by the plurality of stakeholders, the users, and the concierge user via at least one of a user interface and a uniform resource locator on a browsing application on an associated computing device.

According to another aspect of the present disclosure, the method also includes analysing, by a data analysing module, data comprising at least one of visitors' data, facilities' data, vehicles' data, and people profiles' data. The method further includes taking, by the data analysing module, at least one action and learning based on the analysis.

According to another aspect of the present disclosure, the method includes processing and automating, by a payment module, a plurality of payments.

According to another aspect of the present disclosure, the method includes enabling, by a voice processing module, the plurality of users and the plurality of stakeholders to: provide at least one voice command for making one or more payments, wherein the payment module processes the one or more payments based on the at least one voice command; and ask one or more questions related to at least one of the plurality of facilities and the one or more payments via one or more voice questions.

A yet another embodiment of the present disclosure provides a centralised facility management system (hereinafter may also be referred as system) for monitoring and managing a plurality of facilities in real-time. The method includes an audio/visual input module configured to continuously receive a real-time audio/visual feed of the plurality of facilities from a plurality of imaging devices of the plurality of facilities, wherein the audio/visual input module comprises a touch enabled device to enable a concierge user to interact with the centralised facility management system. The system also includes a security module. Based on the real-time audio/visual feed, the security module is also configured to provide a controlled access of a plurality of doors, lockers, parking within and around the plurality of facilities to a plurality of users and vehicles based on an authentication via at least one of voice recognition, facial recognition, and a wireless technology comprising Bluetooth, a Wi-fi, a near field communication (NFC), cellular, and a remote Bluetooth activation. The security module also tracks an entry and exit of the plurality of users and the vehicles into and out of the plurality of facilities in real-time. The security module also registers and authenticates vehicles based on recognition of vehicle information comprising a number plate of the vehicles. The security module also records and responds to an incident comprising a security incident. The system also includes asset managing module configured to automatically monitor and record a performance of a plurality of assets of the plurality of facilities in real-time. The system also includes a request and booking module configured to enable the plurality of users and other users to raise maintenance requests and booking requests for one or more services and an area of the plurality of facilities. The system also includes a pre-settlement module configured to enable a plurality of facility developers to post progress reports, settlement information, owners corporation information comprising move-in rules, inductions. an information display module configured to display information on a display device installed at one or more of the plurality of facilities. The system further includes a communication module configured to automatically send at least one of a communication message and recorded information to a plurality of stakeholders and the plurality of users based on the recorded incident, the maintenance requests, the booking requests, the displayed information, and one or more events comprising at least one of a maintenance issue with an asset, an incident, a security incident, a meeting, a delivery person or parcel arrival, a guest arrival, an inspection time, a celebration, a resident event, a facility/building work, and a community event. The system also includes a storage module configured to store and maintain a central repository including facility information, rules, procedures, information of the plurality of stakeholders and the plurality of users, booking information, a plurality of maintenance records, the booking requests, the maintenance requests, asset information, a plurality of facility/building plans, asset locations, ongoing maintenance/construction work information, the information about facilities' issues, and the audio/visual feed of the plurality of facilities. The system further includes a data analysing module configured to analyse data comprising at least one of visitors' data, facilities' data, vehicles' data, and people profiles' data. The system further includes a payment module configured to process and automate a plurality of payments. The system also includes a voice processing module in communication with the payment module configured to enable the plurality of users and the plurality of stakeholders to provide at least one voice command for making one or more payments, wherein the payment module processes the one or more payments based on the at least one voice command; and ask one or more questions related to at least one of the plurality of facilities and the one or more payments via one or more voice questions.

According to an aspect of the present disclosure, the one or more imaging devices placed in strategic locations in and around respective facility of the plurality of facilities, wherein the one or more imaging devices are configured to continuously provide the real-time audio/visual feed of the respective facility to the audio/visual input module.

According to another aspect of the present disclosure, the plurality of stakeholders comprises a plurality of occupants, strata managers, managing agents, investors, facility managers, administrators, owners, facility developers, tradespersons, banks, property valuers, and purchasers, and security officials.

According to another aspect of the present disclosure, the one or more events comprising at least one of a maintenance issue with an asset, an incident, a security incident, a meeting, a delivery person or parcel arrival, a guest arrival, an inspection time, a celebration, a resident event, a facility/building work, and a community event.

According to another aspect of the present disclosure, the displayed information includes at least one of activities' information, announcements, information about works being carried out in the respective facility, owners' corporation meetings' information, book reading reviews, swimming classes information, gym classes information, resident events information, weather report, yoga classes' information, celebrations information, facility/building works' information, advertisements, and promotional events information.

According to another aspect of the present disclosure, the communication message includes an urgent alert concerning facility operations, facility/building works notification, a parcel delivery notification, a booking message, a meeting notification, a celebration notification, an inspection notification, an announcement, an upcoming event, an inspection, and a promotional event notification.

According to another aspect of the present disclosure, the communication module communicates with the plurality of stakeholders and the plurality of users in a preferred communication mode set by the plurality of stakeholders and the plurality of users, respectively.

According to another aspect of the present disclosure, the centralised facility management system further includes at least one robot installed in each of the plurality of facilities, wherein the robot is configured to assist with checking in guests.

According to another aspect of the present disclosure, the wireless technology further comprises at least one of a Wi-fi, a near field communication (NFC), and cellular.

According to another aspect of the present disclosure, the one or more services includes a laundry service, a cleaning service, a pet grooming and walking service, a concierge service, a vehicle washing/detailing, a telecom or intercom service, an internet service, a maintenance service, and a smoke detector servicing.

### DETAILED DESCRIPTION

Preferred features, embodiments and variations of the invention may be discerned from the following detailed description which provides sufficient information for those skilled in the art to perform the invention. The detailed description is not to be regarded as limiting the scope of the preceding summary of the invention in any way.

The functional units described in this specification have been labelled as devices or modules. A device or module may be implemented in programmable hardware devices such as processors, digital signal processors, central processing units, field programmable gate arrays, programmable array logic, programmable logic devices, cloud processing systems, or the like. The devices and modules may also be implemented in software for execution by various types of processors. An identified device or module may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the device and achieve the stated purpose of the device.

Furthermore, the described features, structures, or characteristics may be combined in any suitable manner in one or more embodiments.

In accordance with the exemplary embodiments, the disclosed computer programs or modules can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages. Other software technologies like Sencha IDE, ReactJS, JavaScript, HTML, Java 7+, Node 8+, IDE e.g. Visual studio code, WebStorm, NPM 4+, CSS Net Core, PostgreSQL may be used to develop the disclosed system.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

Specific embodiments of the present invention are described, by way of example only, with reference to the accompanying drawings, in which:

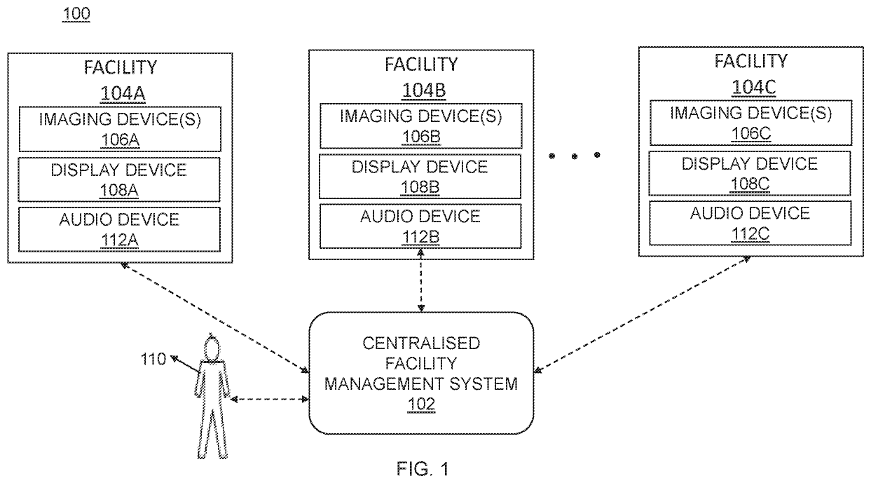

FIG. 1 is a schematic diagram illustrating an exemplary environment 100, where various embodiments of the present disclosure may function;

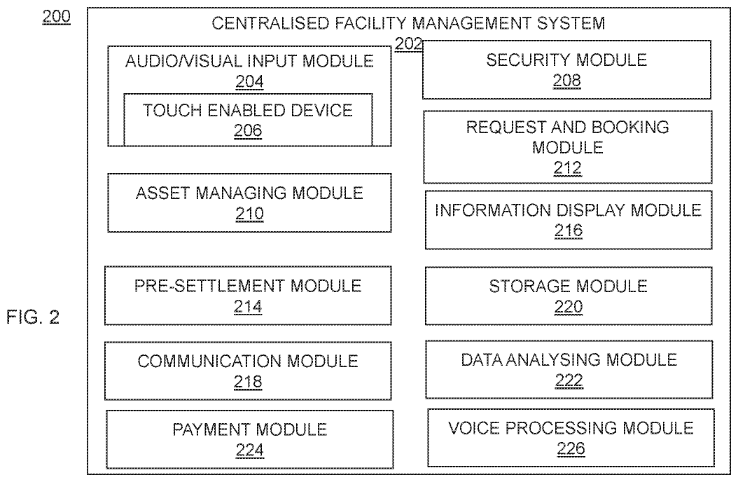

FIG. 2 is a block diagram 200 illustrating various system elements of an exemplary centralised facility management system 202, in accordance with an embodiment of the present disclosure; and

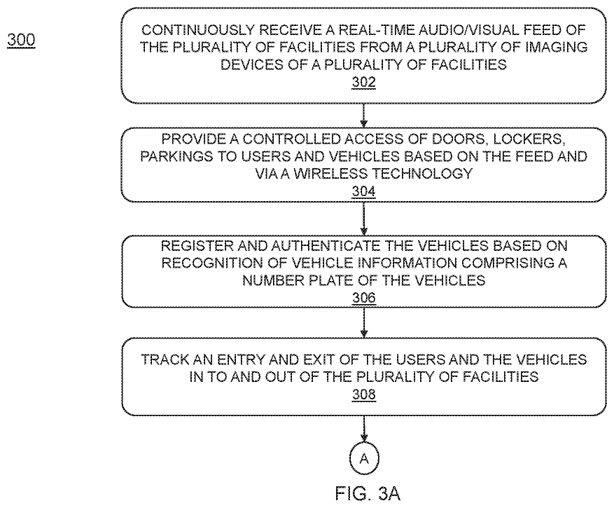

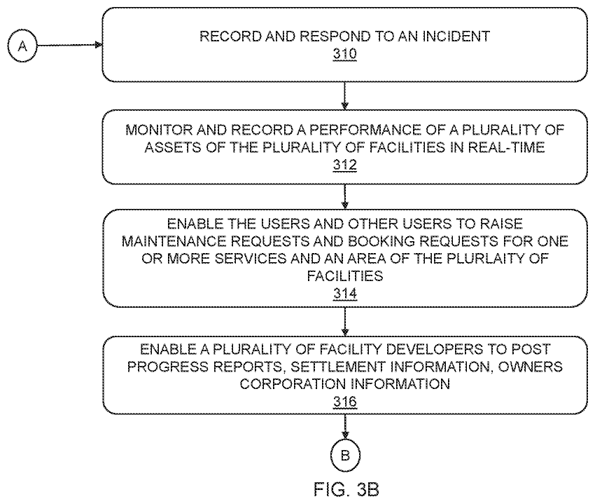

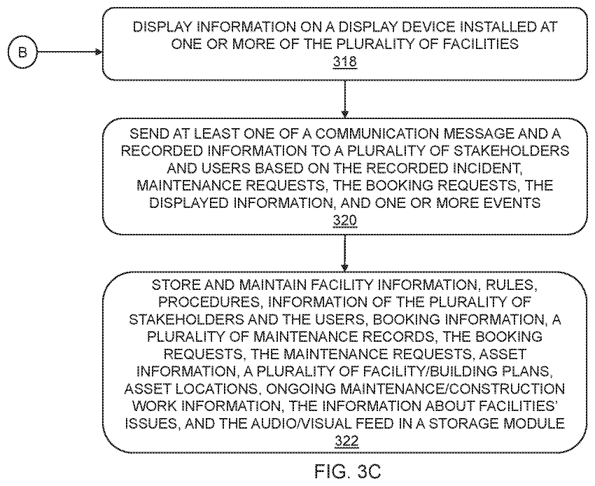

FIGS. 3A-3C is a flowchart diagram illustrating an exemplary method 300 for managing a plurality of facilities, in accordance with an embodiment of the present disclosure.

Referring to the FIG. 1, the exemplary environment 100 includes a centralised facility management system 102 for monitoring and managing a plurality of facilities 104A-104N in real-time. The centralised facility management system 102 may provide one or more concierge services to users of the facilities 104A-104N. Examples of the facilities 104A-104N include, but are not limited to, buildings like residentials buildings, commercial buildings, offices, gated communities, hospitals, community centres, commercial estates, and so forth. Hereinafter, the facilities 104A-104N may also be referred as buildings 104A-104N without change in its meaning. Similarly, the facility may also be referred as a building.

The centralised facility management system 102 may be a single device or module or may include multiple devices or modules configured to perform one or more functionality. Further, the centralised facility management system 102 may include hardware, software, firmware, and combination of these. In some embodiments, the centralised facility management system 102 may be a set of instructions stored on a non-transitory medium like disk drives.

The plurality of facilities 104A-104N includes a plurality of imaging devices 106A-106N. As shown, the facility 104A includes one or more imaging devices 106A, the facility 104B includes one or more imaging devices 106B, and the facility 104N includes one or more imaging devices 106N. In some embodiments, each of the facilities 104A-104N may include one or more imaging devices including at least one of a microphone and an audio device like a speaker.

The imaging devices 106A-106N are installed or placed at strategic locations within or around the respective facility of the facilities 104A-104N. The imaging devices 106A-106N may be any suitable device capable of capturing images/videos and/or processing the images/videos. Examples of the imaging devices 106A-106N may include cameras, webcams, closed circuit television (CCTV) cameras, video cameras, smart cameras, and so forth. The imaging devices 106A-106N, for example, high quality 360-degree cameras, are configured to be installed at strategic locations in different areas within or around the respective facility. The imaging devices 106A-106N like the CCTV cameras may provide a continuous feed, a feedback, and a response to the centralised facility management system 102.

The imaging devices 106A-106N may assist with such as, but not limited to, monitoring deliveries, Airbnb guests, Uber Eats, move in/outs, mail rooms and lockers, trade personnel, public areas and car parking. The imaging devices 106A-106N are configured to continuously provide the real-time audio/visual feed of the respective facility to the centralised facility management system 102. In some embodiments, one or more imaging devices of the imaging devices 106A-106N may include at least one of a microphone and an audio device like a speaker. The centralised facility management system 102 may be located on a remote server and/or on a cloud-based network device.

The centralised facility management system 102 provides support for services and access of the facilities 104A-104N as well as supervision of short stay rentals or guests. The centralised facility management system 102 includes an audio/visual input module including a touch enabled device configured to continuously receive a real-time audio/visual feed of the plurality of facilities 104A-104N from the imaging devices 106A-106N of the plurality of facilities 104A-104N. A concierge user 110 interacts with the centralised facility management system 102 via the touch enabled device. The touch enabled device may be a touch screen kiosk.

The imaging devices 106A-106N may provide a direct visual contact to the concierge user 110 to greet visitors of the respective facility of the facilities 104A-104N via the touch enabled device linked to the concierge user 110. The concierge user 110 may not be physically located at the respective facility of the facilities 104A-104N and may be present in a remote location. The concierge user 110 may direct the visitors to their destination and answer any enquiries.

The centralised facility management system 102 includes a storage module to which the concierge user 110 can refer for accessing information on all aspect of the buildings/facilities 104A-104N for answering the enquiries etc. In some embodiments, the imaging devices 106A-106N may include high quality 360-degree cameras and/or CCTV system placed in strategic locations within and/or around the buildings 104A-104N and feed to the centralised facility management system 102, providing immediate feedback, appropriate response and recording of any incident. The CCTV system assists with monitoring deliveries, short term rentals e.g. Airbnb guests, Uber Eats, move in/outs, mail rooms and lockers, trade personnel, public areas and car parking of the facilities 104A-104N.

The storage module of the centralised facility management system 102 may be a central repository of building (or facility) documentation, information, building plans, asset locations, procedures and rules. Authorised residents, investors, lawyers, conveyancers and real-estate agents, stakeholders etc. can access the important documents in one central database i.e. the storage module. The centralised facility management system 102 is configured to grant a short-term access to users like prospective purchasers and consultants. The storage module may either be a primary memory or a secondary memory. For example, but not restricted to, random access memory (RAM), cache memory, hard disk drive (HDD), solid state drive (SSD), compact disk (CD), portable memories, and like.

The centralised facility management system 102 may allow the service technicians to access building plans and asset locations. The centralised facility management system 102 may also provide detailed assistance to the building management committee to review and monitor the ongoing maintenance of building assets. In some embodiments, the service technicians can access the centralised facility management system 102 via their associated computing device and in turn access information stored in the storage module of the centralised facility management system 102.

Based on the real-time audio/visual feed, the centralised facility management system 102 (hereinafter may also be referred as the centralised facility management system 102, without change in its meaning) may provide a controlled access of a plurality of doors like main door of the building, car parking door, individual apartment door, and so forth, lockers, parking within and around the plurality of facilities 104A-104N to a plurality of users and vehicles based on the real-time audio/visual feed and via a wireless technology comprising Bluetooth. In some embodiments, the wireless technology used for providing controlled access may include, but are not limited to, a Wi-fi, a near field communication (NFC), and cellular. The centralised facility management system 102 may provide easy access to any door fitted with an approved Bluetooth locking device. The centralised facility management system 102 may limit door access to a specific time frame and/or area of the facilities 104A-104N, and can modify an access right at any time and can activate remotely if security access is granted. The centralised facility management system 102 may provide restricted access to specific areas to trades personnel. In some embodiments, the centralised facility management system 102 may provide immediate access to emergency services. Also, the centralised facility management system 102 may activate individual lockers for deliveries and pick-ups, including cool room lockers to keep grocery deliveries fresh. The centralised facility management system 102 may then send an SMS or MMS to an appropriate resident to inform the resident of the delivery.

In some embodiments, based on the real-time audio/visual feed, the centralised facility management system 102 (hereinafter may also be referred as the centralised facility management system 102, without change in its meaning) may provide a controlled access of a plurality of doors like main door of the building, car parking door, individual apartment door, and so forth, lockers, parking within and around the plurality of facilities 104A-104N to a plurality of users and vehicles based on at least one of facial recognition, and voice recognition.

The centralised facility management system 102 is configured to provide immediate information to all the stakeholders, residents, managing agents, strata managers, facility managers and investors including urgent alerts concerning building operations or building works, and individual alerts such as parcel delivery notifications.

Further, based on the real-time audio/visual feed, the centralised facility management system 102 may track an entry and exit of the plurality of users and the vehicles into and out of the plurality of facilities 104A-104N in real-time. In some embodiments, the centralised facility management system 102 may allow visitors and couriers to communicate visually with the concierge user 110 to access the building and unique locker facility. The concierge user 110 can provide building access remotely for emergency services and trades personnel.

Based on the real-time audio/visual feed, the centralised facility management system 102 may also register and authenticate vehicles based on recognition of vehicle information comprising a number plate. In some embodiments, the centralised facility management system 102 may include a number plate recognition system to provide a further layer of security. The number plate recognition system may authenticate and allow only registered vehicles to enter a carpark of the facilities 104A-104N. The centralised facility management system 102 keeps an accurate log of vehicle movements. The centralised facility management system 102 may grant short term carpark access.

Further, based on the real-time audio/visual feed, the centralised facility management system 102 may record and respond to an incident including a security incident.

Further, the centralised facility management system 102 may monitor and record a performance of a plurality of assets of the facilities 104A-104N in real-time. If a maintenance issue is detected, for example a hot water system malfunction, the centralised facility management system 102 may immediately notify a 24/7 maintenance call centre so that a qualified tradesperson can be dispatched to site (i.e. a facility) to repair the asset, this in turn may minimise resident inconvenience.

Further, the centralised facility management system 102 may enable the plurality of users and other users to raise one or more maintenance requests and booking requests for one or more services and a unit of the facilities 104A-104N. Examples of the services may include, but are not limited to, a laundry service, a cleaning service, a pet grooming and walking service, a maintenance service, a vehicle washing/detailing, and a smoke detector servicing.

Further, the centralised facility management system 102 may enable a plurality of facility developers of the facilities 104A-104N (or buildings 104A-104N), respectively, to post progress reports, settlement information, owners corporation information comprising move-in rules, and inductions. In some embodiments, the centralised facility management system 102 may be configured to enable entering of the final inspection details and tracking defect reporting so as to make pre-settlement inspections easy for the facility developers, banks, property valuers, and purchasers.

As shown, the facilities 104A-104N includes a plurality of display devices 108A-108N, respectively. Each of the facilities 104A-104N includes at least one display device, i.e. the facility 104A includes a display device 108A, the facility 104B includes a display device 108B, and the facility 104N includes a display device 108N. Further, each of the facilities 104A-104N may include at least one audio device. For example, the facility 104A includes an audio device 112A, the facility 104B includes an audio device 112B, and the facility 104N includes an audio device 112N. The centralised facility management system 102 is configured to receive audio inputs from the audio devices 112A-112N.

Each of the display devices 108A-108N may include a tenant or residents directory of the facilities 104A-104N, respectively. Further, the centralised facility management system 102 may display information on a display device i.e. one or more of the display devices 108A-108N. Further, the centralised facility management system 102 may present announcements, audio messages, greeting messages, emergency notifications, and so forth on an audio device i.e. one or more of the audio devices 112A-112N. Examples of the audio devices 112A-112N may include, but are not limited to, speakers. In some embodiments, the display devices 108A-108N may be a digital notice board present in the facilities 104A-104N, respectively. Non-limiting examples of the information that may be displayed on the display devices 108A-108N may include, but are not limited to, activities' information, announcements, information about works being carried out in the respective facility of the facilities 104A-104N, owners' corporation meetings' information, book reading reviews, swimming classes information, gym classes information, resident events information, weather report, yoga classes' information, celebrations information, facility/building works' information, advertisements, and promotional events information. In some embodiments, the display devices 108A-108N may include a microphone and an audio device like a speaker. The residents, authorised users etc. may interact with the display devices 108A-108N.

Further, the display devices 108A-108N may display information on activities and works being carried out in the respective facility of the facilities 104A-104N, including owners corporation meetings, book reading reviews, swimming classes, resident events, yoga classes, celebrations and minor/major building (or facilities 104A-104N) works. Further, the centralised facility management system 102 may display advertising on the display devices 108A-108N to promote local and national (or international) businesses and community associations for creating a sense of community among residents. This is facilitated via the digital screen i.e. the display devices 108A-108N located in the building/facility foyer of the respective facilities 104A-104N.

Further, the centralised facility management system 102 may display advertisements on the display devices 108A-108N. Advertising can promote local and national businesses and community associations, creating a sense of community among residents. The centralised facility management system 102 facilitates this via a digital screen i.e. the display devices 108A-108N located in the building/facility foyer.

Further, the centralised facility management system 102 via the display devices 108A-108N of the respective facility may help the visitors to identify the location of tenants within the respective facility or building. In some embodiments, the centralised facility management system 102 via the display devices 108A-108N of the respective facility may help the visitors to identify the location of only those tenants or residents who have authorised the centralised facility management system 102 to access their location within the respective facility or building. This is particularly useful for commercial applications. The centralised facility management system 102 can immediately change or update the display devices 108A-108N at any time.

In some embodiments, the centralised facility management system 102 may display up to date seven-day weather reports, including current temperature and precipitation forecasts, on the display devices like the display device 108A to help residents of a facility like the facility 104A to plan their day-to-day activities. In some embodiments, the display devices 108A-108N are touch enabled screen and may enable the users like residents, stakeholders etc. to access the centralised facility management system 102. For example, the users or authorised users can access information about the facility 104A via the display device 108A.

Further, the centralised facility management system 102 may display latest updates and news on the display devices 108A-108N of the facilities 104A-104N to keep residents up to date with local and world events.

Further, the centralised facility management system 102 may automatically send a communication message and recorded information to at least one of a plurality of stakeholders and the plurality of users based on the recorded incident, the one or more maintenance requests, the booking requests, the displayed information, and one or more events. Examples of the plurality of stakeholders may include, but are not limited to, a plurality of occupants, strata managers, managing agents, investors, facility managers, administrators, facility developers, banks, property valuers, and purchasers, owners, tradespersons, security officials, and so forth. The plurality of users may include visitors, owners, residents, short-term rentals like bed and breakfast guests (e.g. Airbnb guests), and so forth. In some embodiments, the centralised facility management system 102 is configured to send a message and a recorded information to a security official when the security incident is recorded.

The one or more events may include such as, but are not limited to, a maintenance issue with an asset, an incident, a security incident, a meeting, a delivery person or parcel arrival, a guest arrival, an inspection time, a celebration, a resident event, a facility/building work, and a community event. Examples of the communication message may include such as, but are not limited to, an urgent alert concerning facility operations, facility/building works notification, a parcel delivery notification, a booking message, a meeting notification, a celebration notification, an inspection notification, an announcement, an upcoming event, an inspection, and a promotional event notification.

Further, the centralised facility management system 102 may enable stakeholders like building management committee, strata manager or facilities manager to prepare and distribute information to residents and stakeholders, keeping them updated and informed on the latest building activities via communication messages. The communication messages may include at least one of an SMS, MMS, an audio message, an electronic mail (email), a video message, and so forth. This in turn may result in improved communication flow that has the benefit of increasing residents' engagement and creating a closer community.

Further, the centralised facility management system 102 is configured to store and maintain facility information i.e. information of the facilities 104A-104N, rules, procedures, information of the plurality of stakeholders, information of the plurality of users, booking information, a plurality of maintenance records, the booking requests, the maintenance requests, asset information, security officials' information, a plurality of facility/building plans, asset locations, ongoing maintenance/construction work information, the information about facilities' issues, and the audio/visual feed of the plurality of facilities.

In some embodiments, the centralised facility management system 102 is configured to analyse data and may derive one or more information based on the analysis. The data may include such as, but not limited to, visitors' information, data about vehicles entering the facilities 104A-104N, the facility information i.e. information of the facilities 104A-104N, rules, procedures, information of the plurality of stakeholders, the information of the plurality of users, booking information, the plurality of maintenance records, the booking requests, the maintenance requests, asset information, security officials' information, a plurality of facility/building plans, asset locations, ongoing maintenance/construction work information, the information about facilities' issues, and the audio/visual feed of the plurality of facilities.

Further, in some embodiments, the centralised facility management system 102 is configured to optimise its performance and generate one or more reports based on the analysis. In a non-limiting example, the centralised facility management system 102 may generate a report comprising a list of visitors entering a facility 104A between 7 AM-10 AM and 6 PM-9 PM on weekdays. In some embodiments, the centralised facility management system 102 may determine one or more information based on the analysis and may take one or more action based on the analysis. For example, if the centralised facility management system 102 determines that a courier person comes daily between 9 AM to 9:30 AM in the facility 104B on Monday to Saturday, then if the courier person has not come on Thursday between 9 AM-9:30 AM, then the centralised facility management system 102 may inform the residents via message like SMS, or display information on the display device 108B that the courier person did not come today so there will be a delay in mail and courier delivery.

In some embodiments, the stakeholders, the users, and the concierge user 110 can access the centralised facility management system 102 via a user interface on an associated computing device like a mobile phone, a desktop computer, a laptop computer, a tablet computer, a smart watch, a fitness tracker, and so forth. In some embodiments, the user interface may be a client-side facility managing module (or application). The stakeholders, the users, and the concierge user may receive the communication messages, notification, alerts etc. from the centralised facility management system 102 on the computing device. In some embodiments, the stakeholders, the users, and the concierge user 110 can access the centralised facility management system 102 via a uniform resource locator (URL) on a browsing application on the associated computing device. Examples of the browsing application may include Google Chrome, Apple Safari, Firefox Mozilla, Internet Explorer, and so forth. In some embodiments, only the authorised users or the stakeholders and the concierge user 110 are allowed to access the centralised facility management system 102 via the computing device. The users like residents of the facilities 104A-104N can easily identify and report maintenance requests via the user interface on the computing device. The centralised facility management system 102 may keep an accurate log of ongoing repair work in the facilities 104A-104N and provides improved efficiency in tracking, reporting and resolving maintenance requests, maintaining the building to a high standard.

The centralised facility management system 102 may provide a range of concierge services to residents of the facilities 104A-104N, including managing bookings for apartment cleaning, pet grooming and walking, linen laundering, vehicle wash/detailing, smoke detector servicing, and so forth. The centralised facility management system 102 automates the booking of facilities/services of the buildings 104A-104N via an easy-to-use app i.e. the user interface on their computing device. The users can book move-in and move-outs and a range of facilities/services of the buildings 104A-104N including meeting and conference rooms, recreational facilities, building kitchen and entertainment areas, visitor car parking, lifts and loading dock parking.

The centralised facility management system 102 may enable the concierge user 110 to welcome visitors, guests, short stay rentals, residents, etc. to the respective buildings 104A-104N via the via the touch enabled device linked to the concierge user 110. The centralised facility management system 102 may enable registration of visitors, guests, short stay rentals etc. by conducting ID checks and given a building induction. The centralised facility management system 102 may grant limited door access of apartments and shared facilities/premises within the buildings 104A-104N to the visitors, guests, short stay rentals by Bluetooth activation. The centralised facility management system 102 may use number plate recognition to record vehicle park entry and exit for the vehicles of the visitors, guests, short stay rentals.

The centralised facility management system 102 provides easy access to any door or to Bluetooth car parking spaces fitted with an approved Bluetooth locking device in the building or building premises. Door access can be limited to a specific time frame and/or area, modified at any time and can be activated remotely if security access is granted.

The centralised facility management system 102 is configured for live building asset monitoring the facilities 104A-104N and predictive asset maintenance of assets of the facilities 104A-104N.

In some embodiments, the centralised facility management system 102 is configured to provide access to Bluetooth vacuum cleaners of the facilities 104A-104N. In some embodiments, the centralised facility management system 102 is configured to communicate with each individual i.e. the plurality of stakeholders, plurality of users (like visitors, residents, etc.) in their preferred communication mode. Non limiting examples of the communication mode may include a messenger, a text, an email, an SMS, an MMS, an audio message, Weechat etc.

Further, the centralised facility management system 102 may enable the users like a tenant or the property (apartment or home) owner to pay one or more fees such as, but not limited to, their strata fees or part of those fees. In some embodiments, the centralised facility management system 102 enables the users like a tenant or the property (apartment or home) owner to pay one or more fees such as, but not limited to, their strata fees or part of those fees by providing voice commands and also enable the user to ask questions about their fees or other aspects of the property or building and receive a response. The centralised facility management system 102 may use an artificial intelligence (AI) functionality for processing and automating the payments. In some embodiments, the centralised facility management system 102 is configured to automate the payments by using automation of accounts of the users. In some embodiments, the centralised facility management system 102 may use blockchain techniques to automate accounts, and automatically pay suppliers and interact with strata or facility/building/property accounting software. The blockchain may be an open, distributed ledger adapted to record transactions between two or more parties efficiently and in a verifiable and permanent way.

Referring to the FIG. 2, the block diagram 200 illustrates various system elements of the exemplary centralised facility management system 202, in accordance with an embodiment of the present disclosure. As shown, the centralised facility management system 202 (hereinafter may also be referred as system 202) includes an audio/visual input module 204, a security module 208, an asset managing module 210, a request and booking module 212, a pre-settlement module 214, an information display module 216, a communication module 218, a storage module 220, a data analysing module 222, a payment module 224, and a voice processing module 226. The audio/visual input module 204 also includes a touch enabled device 206. The centralised facility management system 202 is a centralised system configured for monitoring and managing multiple facilities at same time. In some embodiments, the one or modules 204-226 of the centralised facility management system 202 are present in a cloud-based network. In alternative embodiments, the one or modules 204-226 of the centralised facility management system 202 are present in a network device like a server.

Further, a plurality of stakeholders, a plurality of users, and the concierge user 110 can access the centralised facility management system 202 via at least one of a user interface and a uniform resource locator on a browsing application on an associated computing device. Examples of the computing device may include a laptop computer, a desktop computer, a tablet computer, a smart phone, a smart watch, a fitness tracker, a smart television, and any suitable device with computing capability. In some embodiments, the user interface may be a client-side facility managing module (or application). The user interface, presented on the computing device, may be through a software application installed on the computing device, or through a web interface.

The audio/visual input module 204 is configured to continuously receive a real-time audio/visual feed of the plurality of facilities like the facilities 104A-104N from a plurality of imaging devices like the imaging devices 106A-106N of the plurality of facilities 104A-104N. In some embodiments, one or more of the imaging devices 106A-106N may include at least one of a microphone and an audio device like a speaker. The audio/visual input module 204 is also configured to receive audio inputs from the audio devices 112A-112N. The audio/visual input module 204 includes the touch enabled device 206 to enable the concierge user 110 to interact with the centralised facility management system 202. The touch enabled device 206 may be a touch screen kiosk located remotely from the facilities 104A-104N. For example, the centralised facility management system 202 (or 102) including the touch screen kiosk may be present at a remote location with respect to the location of the facilities 104A-104N. the imaging devices 106A-106N are placed in strategic locations in and around respective facility of the facilities/buildings 104A-104N. The imaging devices 106A-106N are configured to continuously provide the real-time audio/visual feed of the respective facility to the audio/visual input module 204. The strategically placed imaging devices 106A-106N, like CCTV cameras, enables the centralised facility management system 102 to provide 24/7 real-time security monitoring to keep buildings 104A-104N and occupants safe. The centralised facility management system 202 can respond immediately to emergency situations and contact first responders. Suspicious or criminal activity is reported to Police immediately and CCTV footage records the activity. The concierge user 110 of the centralised facility management system 202 can talk to perpetrators via the touch screen device or kiosks, assisting to control the situation. The centralised facility management system 102 helps to keep occupants safe and secure.

The centralised facility management system 202 may provide a direct visual contact to greet visitors to the buildings like 104A via the touch screen devices linked to the concierge user 110 in a control room of the system, directing them to their destination, and answering any enquiries. The concierge user 110 can access information on all aspects of the building 104A (or the buildings 104A-104N) from the centralised facility management system 202.

Based on the real-time audio/visual feed, the security module 208 is configured to provide a controlled access of a plurality of doors, lockers, parking within and around the plurality of facilities to a plurality of users and vehicles based on the real-time audio/visual feed and via at least one of voice recognition, facial recognition, and a wireless technology comprising Bluetooth. Other examples of the wireless technology may include a near field communication (NFC), cellular, and so forth. In some embodiments, the security module 208 uses Bluetooth technology to provide door access and car park access and may use number plate recognition system to track and log car park entries and controls building access to couriers and deliveries. This provides another layer of security to the residents.

Based on the real-time audio/visual feed, the security module 208 is configured to provide a controlled access of a plurality of doors, lockers, parking within and around the plurality of facilities to a plurality of users and vehicles based on at least one of facial recognition and voice recognition. Further, the security module 208 is configured to provide access to Bluetooth carpark locks to authorized users or visitors.

The security module 208 is further configured to track an entry and exit of the plurality of users and the vehicles into and out of the plurality of facilities in real-time. The security module 208 is further configured to track an entry and exit of the plurality of users and the vehicles into and out of the plurality of facilities 104A-104N in real-time. In some embodiments, for each of the buildings 104A-104N, the security module 208 may maintain a log of entries and exits of the users and vehicles into or out of the buildings 104A-104N. This log may be stored in the storage module 220. The building managers or other administrative users can access the log via the centralised facility management system 202. Further, the security module 208 is configured to record and respond to an incident such as a security incident based on the received audio/visual feed.

The asset managing module 210 is configured to monitor and record a performance of a plurality of assets of each of the facilities 104A-104N in real-time.

The request and booking module 212 is configured to enable the plurality of users and other users to raise one or more maintenance requests and booking requests for one or more services and a unit of the facilities 104A-104N. The unit of the facilities 104A-104N may include like an apartment/flat of the facilities 104A-104N, a parking area/unit, a common area, a lobby, a play area, a tennis court, an open area, a mail box, a locker, a storage area, a hall, a gym, a swimming area of the facilities 104A-104N and so forth. The users can be any occupant of the facilities 104A-104N such as a resident, an owner, a landlord, or any other user like an authorised user, a short stay rental guest, a visitor, and so forth. The one or more services may include such as, but not limited to, a laundry service, a cleaning service, a pet grooming and walking service, a concierge service, a vehicle washing/detailing, a maintenance service, a telecom or intercom service, an internet service, a plumbing service, and a smoke detector servicing.

The pre-settlement module 214 is configured to enable a plurality of facility developers to post progress reports, settlement information, owners corporation information including move-in rules, and inductions. The move-in rules may be a set of rules for new occupants when they move-into a building of the buildings 104A-104N. The pre-settlement module 214 is further configured to enable (or enable users or other stakeholders) entering of the final inspection details and tracking defect reporting so as to make pre-settlement inspections easy for the facility developers, banks, property valuers, and purchasers.

The information display module 216 is configured to display information on a display device installed at each of the facilities 104A-104N. The information display module 216 displays information on the display devices 108A-108N installed at each of the facilities 104A-104N, respectively. The displayed information comprising at least one of activities' information, announcements, information about works being carried out in the respective facility, owners' corporation meetings' information, book reading reviews, swimming classes information, gym classes information, resident events information, weather report, yoga classes' information, celebrations information, facility/building works' information, advertisements, and promotional events information. Each of the display devices 108A-108N may include a tenant or residents directory.

The communication module 218 is configured to automatically send at least one of a communication message and a recorded information to at least one of a plurality of stakeholders and the plurality of users based on the recorded incident, the one or more maintenance requests, the booking requests, the displayed information, and one or more events. The communication message may be an urgent alert concerning facility operations, facility/building works notification, a parcel delivery notification, a booking message, a meeting notification, a celebration notification, an inspection notification, an announcement, an upcoming event, an inspection, a promotional event notification, and so forth.

Examples of the plurality of stakeholders includes, but are not limited to, a plurality of occupants, strata managers, managing agents, investors, facility managers, administrators, owners, facility developers, tradespersons, banks, property valuers, and purchasers, and security officials. The one or more events may include, but are not limited to, a maintenance issue with an asset, an incident, a security incident, a meeting, a delivery person or parcel arrival, a guest arrival, an inspection time, a celebration, a resident event, a facility/building work, and a community event.

In some embodiments, the communication module 218 is configured to send a message and a recorded information to a security official when the security incident is recorded. For example, if based on the audio/visual feed the security module 208 detects or records a theft or suspicious activity within or around a building like the building 104A, then the communication module 218 automatically sends a message to notify security official like Police of that area and/or building manager, security etc. about the security incident immediately. In some embodiments, the communication module 218 sends the recorded information like a CCTV footage, camera images, and so forth along with the message to the Police. The building manager, security, the Police may receive the message and/or the recorded information on their associated computing device like a computer, laptop, phone, etc. In some embodiments, the communication module 218 sends the message and/or the recorded information as an electronic email, SMS, MMS, and so forth. In alternative embodiments, the communication module 218 sends a link i.e. a uniform resource locator (URL), to access the message and/or the recorded information to the security officials.

The storage module 220 of the centralised facility management system 202 is configured to store and maintain information about the facilities, residents, people, visitors, facility managers, strata managers, and so forth. The information may include, but is not limited to, facility information, rules, procedures, information of the plurality of stakeholders, information of the plurality of users, booking information, a plurality of maintenance records, the booking requests, the maintenance requests, asset information, security officials' information, a plurality of facility/building plans, asset locations, ongoing maintenance/construction work information, activities information, the information about facilities' issues, and the audio/visual feed of the plurality of facilities. The storage module 220 may either be a primary memory or a secondary memory. For example, but not restricted to, random access memory (RAM), cache memory, hard disk drive (HDD), solid state drive (SSD), compact disk (CD), portable memories, and like. The storage module 220 may also store a plurality of instructions that can be executed by the one or more of the modules 204-218 and 222-226 of the system 202.

The data analysing module 222 is configured to analyse data comprising at least one of visitors' data, facilities' data, vehicles' data, and people profiles' data. The people profiles' data may include residents' data of the tenants, landlords, short stay rentals guests, and so forth. Further, the data analysing module 222 is configured to take at least one action and learn based on the analysis. The data analysing module 222 may analyse the data to optimize the centralised facility management system 202 and for self-learning purposes. In some embodiments, the data may be analysed using various artificial intelligence (AI) based techniques and data analytics methods.

In some embodiments, the data analysing module 222 is configured to analyse data and may derive one or more information based on the analysis. As discussed with reference to the FIG. 1, the data may include such as, but not limited to, people profiles, residents' information, visitors' information, data about vehicles entering the facilities 104A-104N, the facility/building data i.e. information of the facilities 104A-104N, rules, procedures, information of the plurality of stakeholders, the information of the plurality of users, booking information, the plurality of maintenance records, the booking requests, the maintenance requests, asset information, security officials' information, a plurality of facility/building plans, asset locations, ongoing maintenance/construction work information, the information about facilities' issues, and the audio/visual feed of the plurality of facilities.

Further, in some embodiments, the data analysing module 222 is configured to optimise its performance and learn based on the analysis. Further, the data analysing module 222 is configured to generate one or more reports based on the analysis. In a non-limiting example, the data analysing module 222 may generate a report having a list of visitors entering a facility 104A between 7 AM-10 AM and 6 PM-9 PM on weekdays. In some embodiments, the data analysing module 222 may determine one or more information based on the analysis and may take one or more action based on the analysis. For example, based on the analysis, if the data analysing module 222 determines that a courier person comes daily between 9 AM to 9:30 AM in the facility 104B on Monday to Saturday, then if the courier person has not come on Thursday between 9 AM-9:30 AM, then the data analysing module 222 may automatically inform the residents via message like SMS, or display information on the display device 108B that the courier person did not come today so there will be a delay in mail and courier delivery.

The payment module 224 is configured to process and automate a plurality of payments. The plurality of payments may include payment of a strata fee, a rent, a short stay rent, a booking fee, a maintenance fee, a parking fee, a repair work payment, and so forth. In some embodiments, the users may set instructions for auto debit of one or more fees from their account like bank account or credit card account etc. via the payment module 224.

The voice processing module 226 is in communication with the payment module 224 and is configured to enable the plurality of users and the plurality of stakeholders to provide at least one voice command for making one or more payments. The payment module 224 may process the one or more payments based on the at least one voice command. For example, the user like a tenant can pay a rent by providing a voice command via a user interface on their associated computing device in communication with the central facility management system 202. The voice command is processed by the voice processing module 226 and the payment module 224 processes the payment of the tenant's rent based on the voice command.

In some embodiments, the voice processing module 226 may also enable the plurality of users and the plurality of stakeholders to ask one or more questions related to at least one of the plurality of facilities and the one or more payments via voice questions. In some embodiments, the plurality of users and the plurality of stakeholders may ask one or more questions via at least one of text message, email, voice questions, chat, and so forth.

In some embodiments, the voice processing module 226 may enable the user like a tenant or the property (apartment or home) owner to pay their strata fees or part of those fees by providing voice commands and also enable the user to ask questions about their fees or other aspects of the property or building and receive a response. The payment module 224 may use an AI functionality for processing payment. In some embodiments, the payment module 224 is configured to automate the payment by using automation of accounts of the users. In some embodiments, the payment module 224 may use block chain techniques to automate accounts, and automatically pay suppliers and interact with strata or facility/building/property accounting software.

In some embodiments, the payment module 224 may connect with third party payment software for processing the payments. Further, the payment module 224 is configured to be used with and adapted to any of the existing and future developed payment software and payment gateways.

In some embodiments, the stakeholders, the users, and the concierge user 110 can access the centralised facility management system 202 via a user interface on an associated computing device like a mobile phone, a desktop computer, a laptop computer, a tablet computer, a smart watch, a fitness tracker, and so forth. In some embodiments, the user interface may be a client-side facility managing module (or application). The stakeholders, the users, and the concierge user may receive the communication messages, notification, alerts etc. from the centralised facility management system 202 on the computing device. In some embodiments, the stakeholders, the users, and the concierge user 110 can access the centralised facility management system 202 via a uniform resource locator (URL) on a browsing application on the associated computing device. Examples of the browsing application may include Google Chrome, Apple Safari, Firefox Mozilla, Internet Explorer, and so forth. In some embodiments, only the authorised users or the stakeholders and the concierge user 110 are allowed to access the centralised facility management system 202 via the computing device. The users like residents of the facilities 104A-104N can easily identify and report maintenance requests via the user interface on the computing device. The centralised facility management system 202 may keep an accurate log of ongoing repair work in the facilities 104A-104N and provides improved efficiency in tracking, reporting and resolving maintenance requests, maintaining the building to a high standard.

Referring to the FIGS. 3A-3C, the flowchart diagram illustrating the exemplary method 300 of managing a facility, in accordance with an embodiment of the present disclosure. As discussed with references to the FIG. 1 and FIG. 2, the centralised facility management system 202 (or 102) can monitor and manage the plurality of facilities or buildings 104N-104N simultaneously in real-time. The centralised facility management system 202 includes the audio/visual input module 204, the security module 208, the asset managing module 210, the request and booking module 212, the pre-settlement module 214, the information display module 216, the communication module 218, and the storage module 220. The audio/visual input module 204 also includes the touch enabled device 206. The facilities 104A-104N includes the imaging devices 106A-106N, respectively. Further, the facilities 104A-104N includes the display devices 108A-108N, respectively. Each of the facilities includes one of the display devices 108A-108N.

At step 302, the audio/visual input module 204 continuously receives a real-time audio/visual feed of the plurality of facilities 104A-104N from the plurality of imaging devices 106A-106N of the plurality of facilities 104A-104N. The audio/visual input module 204 includes the touch enabled device 206 to enable a concierge user like the concierge user 110 to interact with the centralised facility management system 202. The imaging devices 106A-106N may include cameras, video cameras, CCTV cameras, web cameras, and so forth. For example, the audio/visual input module 204 can continuously receive a real-time audio/visual feed of the facility 104A from one or more imaging devices 106A. The cameras may be High quality 360-degree cameras placed in strategic locations within and around the building 104A to provide the audio/visual feed to the audio/visual input module 204. The imaging devices 106A may provide immediate feedback, appropriate response and recording of any incident. The cameras including a CCTV system may assist with monitoring deliveries, Airbnb guests, Uber Eats, move in/outs, mail rooms and lockers, trade personnel, public areas and car parking in the building 104A.

At step 304, the security module 208 provides a controlled access of a plurality of doors, lockers, parking within and/or around the facilities 104A-104N to a plurality of users and a plurality of vehicles based on the real-time audio/visual feed and via a wireless technology comprising Bluetooth. For example, the security module 208 may provide an access of a front door and an access of an apartment door within the facility 104A to a short stay rental guest like an Airbnb guest via remote Bluetooth activation.

At step 306, the security module 208 may register and authenticate the vehicles based on recognition of vehicle information, such as, but not limited to, a number plate of the vehicles. For example, the security module 208 may register a vehicle like a car of the Airbnb guest based on the number plate of the car and may provide access to the car to the building 104A based on the number plate recognition.

At step 308, the security module 208 tracks an entry and exit of the users and the vehicles into and out of the facilities 104A-104N. For example, the security module may track an entry and exit of the Airbnb guest and his/her associated car into and out of the building 104A.

At step 310, the security module 208 records and responds to an incident such as a security incident. For example, if there is an or an attempt of unauthorised entry of a person or a car into the building then the security module 208 may inform a building manager of the building 104A and police of that area. In some embodiments, the security module 208 may sent a CCTV recording of the duration when this incident is recorded to the police, the building manager, and other stakeholders.

At step 312, the asset managing module 210 monitors and records a performance of a plurality of assets of the plurality of facilities in real-time. For example, the asset managing module 210 monitors and records a performance of assets of the building 104A. In some embodiments, the asset managing module 210 may also detect any fault/issue in the asset, the communication module 218 can report the issue to an associated authority or tradesperson to fix the issue. For example, if there is a water pipes issue in the building 104A detected by the asset managing module 210, then the communication module 218 can immediately notify a plumber about the issue and may also send other details like location of the building 104A etc. This way the issue can be attended immediately and inconvenience caused to the residents can be minimised.

At step 314, the request and booking module 212 enables the plurality of users and other users to raise one or more maintenance requests and booking requests for one or more services and a unit like an apartment of the plurality of facilities. Examples of the one or more services may include, but are not limited to, a laundry service, a cleaning service, a pet grooming and walking service, a vehicle washing/detailing, a maintenance service, and a smoke detector servicing.

At step 316, the pre-settlement module 214 enables a plurality of facility developers to post progress reports, settlement information, owners corporation information comprising move-in rules, and inductions. The pre-settlement module 214 also enables entering of the final inspection details and tracking defect reporting so as to make pre-settlement inspections easy for the facility developers, banks, property valuers, and purchasers.

At step 318, the information display module 216 displays information on a display device like the display devices 108A-108N installed at each of the facilities 104A-104N. For example, the information display module 216 displays information like weather report, news, advertisement, gym classes schedule, celebrations' schedule, and so forth related to the building 104A on the display device 108A. The occupants like residents of the building 104A can view the information on the display device 108A. Other non-limiting examples of the displayed information may include activities' information, announcements, information about works being carried out in the respective facility, owners' corporation meetings' information, book reading reviews, swimming classes information, gym classes information, resident events information, weather report, yoga classes' information, celebrations information, facility/building works' information, advertisements, promotional events information, and so forth.

At step 320, the communication module 218 automatically sends at least one of a communication message and a recorded information to at least one of a plurality of stakeholders and the plurality of users based on the recorded incident, the one or more maintenance requests, the booking requests, the displayed information, and one or more events. Examples of the one or more events may include such as, but are not limited to, a maintenance issue with an asset, an incident, a security incident, a meeting, a delivery person or parcel arrival, a guest arrival, an inspection time, a celebration, a resident event, a facility/building work, and a community event. The communication module 218 sends a message like an SMS or email, and a recorded information like a CCTV footage to a security official like Police when the security incident is recorded.

At step 322, the facility information, rules, procedures, information of the plurality of stakeholders and the users, booking information, activities information, a plurality of maintenance records, the booking requests, the maintenance requests, asset information, a plurality of facility/building plans, asset locations, ongoing maintenance/construction work information, the information about facilities' issues, and the audio/visual feed are stored in the storage module 220. The storage module 220 also maintains the stored information for future access by the users, stakeholders etc. The storage module 220 may also store pre-programmed alerts, pre-defined messages, actions, and so forth.

Strategically placed imaging devices like CCTV cameras of the buildings enables the disclosed centralised facility management system to provide 24/7 real-time security monitoring to keep buildings and occupants safe. The disclosed system can respond immediately to emergency situations and contact first responders. Suspicious or criminal activity is reported to Police immediately and CCTV footage records the activity. The concierge user of the disclosed system can talk to perpetrators via the touch screen kiosks, assisting to control the situation. The disclosed system helps to keep occupants safe and secure.

The disclosed centralised facility management system continuously monitors and records performance of building assets in real time. For example, if a maintenance issue is detected, like a hot water system malfunction, the management system may immediately notify a 24/7 maintenance call centre so that a qualified tradesperson can be dispatched to site, i.e. the building, to repair the asset, minimising resident inconvenience.

In some embodiments, the disclosed centralised facility management system includes robots to assist with checking in guests in one or more facilities/buildings/property. The robots may be physically present in the one or more facilities/buildings/property and the centralised facility management system may control the robots. The robots may be configured to be controlled via such as, but not limited to, voice commands or pre-fed instructions.

In some embodiments, the disclosed centralised facility management system is configured for live building asset monitoring and predictive asset maintenance.

In some embodiments, the disclosed centralised facility management system is configured to provide a controlled access to Bluetooth vacuum cleaners in the facilities. The centralised facility management system is configured to control the Bluetooth vacuum cleaners.

In some embodiments, the disclosed centralised facility management system is configured to communicate with a plurality of users like visitors, residents, facility developers, landlords, short stay rental guests, and so forth in users' preferred communication mode. Examples of the communication mode includes a messenger, a text message, an email, Weechat, audio message, and so forth.

The disclosed centralised facility management system directs and monitors deliveries to the right apartment of the building(s) and then notifies the owner of the apartment via a message like an SMS or an email. The centralised facility management system may provide remote Bluetooth access to cool room lockers so that grocery deliveries stay fresh. Further, the centralised facility management system may monitor move ins/move outs and Airbnb guests—Bluetooth activated door locks removes the need for supplying keys or keypad locks for guests.

The disclosed centralised facility management system may coordinate services via an electronic booking system i.e. the request and booking module (See 212 of FIG. 2). The disclosed centralised facility management system can facilitate maintenance and repair jobs, apartment cleaning including changing sheets for short-stay arrangements, washing and maintaining cars and bikes including booking services, arranging flower deliveries, walking and caring for pets when residents are away, among many other services.

In some embodiment, the disclosed centralised facility management system may include a training module configured to conduct training sessions of a plurality of users like concierge user about regulation, legislation, and case studies relating to building management industry. Therefore, the users will be equipped with the most current knowledge to handle issues relating to OC management. In some embodiments, the disclosed centralised facility management system may receive inputs or training modules from legal users like lawyers or legal counsel to implement robust processes and procedures to ensure Owners Committees are operating within the law, hence minimising any risk.

The disclosed centralised facility management system may monitor building's essential services such as elevators and hot water services and may text all building owners if an issue with a service arises. The disclosed centralised facility management system may also coordinate the service's prompt repair through our in-house 24 by seven repairs and maintenance affiliated business. The disclosed centralised facility management system may inform in-house, professional and reliable tradespersons about issues so that they can attend to requests quickly and competently.

The disclosed centralised facility management system may provide 24-hour concierge and security service to buildings comprising small to medium-sized buildings in a cost-effective manner.

The disclosed centralised facility management system may result in improved efficiency in reporting and tracking maintenance requests. The centralised facility management system may provide onsite coordination of facility bookings and building maintenance. Further, the centralised facility management system may provide a centralised point for building information and communications. Further, the centralised facility management system may provide a centralised repository of building documentation and information. Furthermore, the centralised facility management system may provide building security and real-time monitoring for increased safety.

The disclosed centralised facility management system can be used to monitor any building anywhere in the world. The centralised facility management system may also integrate new technical innovations, products and services as they emerge. In some embodiments, the centralised facility management system may include a voting module for enabling online voting for Owners Corporation committees.

The disclosed centralised facility management system may provide maintenance and repairs services, property management services, real estate services, owners' corporation management and more to facilities and stakeholders.

The disclosed centralised facility management system may include a user interface that can enable residents of the building to easily identify and report maintenance requests. The user interface may be provided as a mobile phone application on a computing device of the residents. The centralised facility management system is configured to keep an accurate log of ongoing repair work and may provide an improved efficiency in tracking, reporting and resolving maintenance requests, maintaining the building to a high standard.

The disclosed centralised facility management system may be used as a 24 by 7 concierge system for one building or multiple buildings. The disclosed centralised facility management system may be configured to monitor and manage multiple buildings simultaneously. The multiple buildings may be located at different locations or different countries, cities, continents, etc.

The disclosed centralised facility management system may communicate with a plurality of imaging devices of a building (or multiple buildings) for receiving a continuous audio/visual feed. The building includes multiple imaging devices and a display device. The imaging devices may include high quality 360-degree cameras or CCTV system placed in strategic locations around the building and feed to an audio/visual input module of the management system, providing immediate feedback, appropriate response and recording of any incident. The CCTV system may assist with monitoring deliveries, short stay rentals guests, food delivery persons, move in/outs, mail rooms and lockers, trade personnel, public areas and car parking.

In some embodiments, the disclosed centralised facility management system may be configured to activate individual lockers for deliveries and pick-ups, including cool room lockers to keep grocery deliveries fresh. The centralised facility management system may also be configured to send a message like an SMS to appropriate resident or user to inform about the delivery.

In some embodiments, the disclosed centralised facility management system may be configured to provide a range of concierge services to residents, including managing bookings for apartment cleaning, pet grooming and walking, linen laundering, vehicle wash/detailing and smoke detector servicing.

In some embodiments, the disclosed centralised facility management system includes a storage module including a central repository of building documentation, information, procedures and rules. Authorised residents, investors, lawyers, conveyancers, and real estate agents can access important documents in one central location from the central repository. Further, the centralised facility management system may grant a short-term access of the central repository to prospective purchasers and consultants.

In some embodiments, the disclosed centralised facility management system may create a sense of community among residents by providing a central point for building/facility communications. The centralised facility management system can notify residents and stakeholders of upcoming events such as owners corporation meetings, yoga classes, gym classes, resident drinks and celebrations.

In some embodiments, the disclosed centralised facility management system may perform many administrative tasks of the property managers, building managers, real estate staff, strata managers, and so forth so that it frees up their time to concentrate on customer service and feedback, market analysis and business development. The centralised facility management system may be configured to receive and seek feedback from users, stakeholders etc. and may identify opportunities.

The disclosed centralised facility management system may allow visitors and couriers to communicate visually with the centralised facility management system to access the building and/or unique locker facility. The centralised facility management system can provide building access remotely for emergency services and trades personnel.

In some embodiments, the disclosed centralised facility management system may manage short stay rentals and visitors like Airbnb guests. The centralised facility management system may solve security and safety issues related to short-stay rentals guests. Further, the centralised facility management system may improve quality of life of the residents as usually residents fear an increase in noise and bad behaviour by the short-stay rentals. The disclosed centralised facility management system may be configured to handle amenities issue, including untidiness of common areas and over-use of amenities. Further, the centralised facility management system is configured to report incidents like property damage and thefts within the facilities/buildings. The disclosed centralised facility management system may also resolve various security issues by controlling building access via Bluetooth technologies. This may in turn reduce the risk of key copying by the short-stay rentals and key pad issues.

In some embodiments, the disclosed centralised facility management system may include a security module including a number plate recognition system to provides a further layer of security. The number plate recognition system ensures that only registered vehicles can enter the carpark and the system keeps an accurate log of vehicle movements. The centralised facility management system may grant short term carpark access to one or more users.

The disclosed centralised facility management system may provide immediate information to all stakeholders, residents, managing agents, strata managers, facility managers and investors including urgent alerts concerning building operations or building works, and individual alerts such as parcel delivery notifications.

In some embodiments, the disclosed centralised facility management system may be configured to control front door, car park, and individual apartment door access of a building or facility via remote Bluetooth activation. The centralised facility management system therefore removes challenges from owners of guest access, including copying keys or keypad issues of PIN updates, guests losing the PIN or malfunctions, leaving guests stranded. The disclosed centralised facility management system checks identification of guests and maintains an accurate log of who enters the property and the car park, and ensure guest numbers are not exceeded. The centralised facility management system can coordinate cleaning of apartments, including changing the sheets, assisting with short-stay letting.

The disclosed centralised facility management system may increase liveability by responding to anti-social behaviour—residents can contact or access the system or the concierge service/user of the centralised facility management system at any time of the day or night to report bad behaviour, and the centralised facility management system may automatically act accordingly by either contacting the resident directly or contacting the police if necessary.

The disclosed centralised facility management system may include an information display module configured to display information on a display device installed at the building. The display device (may also be referred as a building directory board or digital screen/board) may help visitors to identify a location of tenants within the building. This is particularly useful for commercial applications. The information display module can immediately update or change a display of the display device. The information displayed on display devices by the information display module may further create a sense of community, providing up to date information on activities to residents, users, etc. The information display module may inform residents of upcoming events such as OC meetings, social/communal events such as Friday afternoon drinks and Christmas parties, organised activities such as yoga, book clubs and gym classes, and information on building works to lessen the inconvenience. The centralised facility management system may also provide a directory including information of residents etc. via the display device to allows visitors to locate tenants—applicable to residential and commercial buildings.

The disclosed centralised facility management system increases the ease of apartment living. If the centralised facility management system detects a fault with a building, for example the elevator, hot water service or electrical outages, then the centralised facility management system sends an SMS to all the residents of the building immediately to minimise their inconvenience, and promptly organises repair of the fault. The centralised facility management system can coordinate and receive deliveries to remove the logistical difficulty this often poses.

The disclosed centralised facility management system may provide a pre-leasing model to reduce the inherent risk to developers of slow pre-sales or pre-commitments. Reduced risk may build developer's confidence in the country's market, may drive apartment sales and allow them to secure the capital required. This may drive apartment construction, a great benefit to the property market. The centralised facility management system may further allow the developers to secure a bulk lot of apartments in large developments that would have otherwise been purely residential. This has a flow-on effect for assisting the rental market—addressing the shortage of short-stay dwellings and over-supply of residential apartments.

The disclosed centralised facility management system may provide an ethical and customised approach to facility/building/office/property/contractor/strata management to ensure that all landlords receive a fair deal and are not paying for services they do not need or use. The centralised facility management system may provide landlords and tenants with an access to a 24 by 7 hotline number ensuring that urgent repairs are attended to quickly by in-house professional tradespersons. The centralised facility management system ensures that important safety features such as fire alarms, sprinklers and electricals of the building are in an excellent working order, giving tenants and landlords peace of mind.

The disclosed centralised facility management system may provide a revenue stream for owners and/or an administrator of the centralised facility management system by incorporating advertising into the touch enabled devices of the centralised facility management system and display devices at the buildings. The centralised facility management system may be used by local businesses and organisations for promoting targeted product/service offerings, deals to residents of the buildings. This in turn may assist to foster the development of community. In some embodiments, the centralised facility management system may enable the owners and/or the administrator of the centralised facility management system to divert this revenue stream to a charity of choice, creating a goodwill and providing much needed funds to those in need.

The disclosed centralised facility management system may include a request and booking module configured to automate the booking of building facilities via the user interface of the management system provided to the users on their associated computing device. The management system enables the users to book move-in and move-outs and a range of building facilities including meeting and conference rooms, recreational facilities, building kitchen and entertainment areas, visitor car parking, lifts and loading dock parking.

The disclosed centralised facility management system is a self-learning system. The disclosed centralised facility management system is configured to receive and/or capture data and analyse the data to optimize the system and for self-learning purposes. Examples of the data may include, such as, but not limited to, visitors' data, facilities' data, vehicles' data, and people profiles' data. The people profiles' data may include residents' data of the tenants, landlords, short stay rentals guests, and so forth. In some embodiments, the data may be analysed using various artificial intelligence (AI) based techniques and data analytics methods.

The disclosed centralised facility management system may enhance the liveability of multi-dwelling and commercial buildings for occupants and owners. The centralised facility management system solves many of the challenges of medium and high density living, including easily accessible centralised building information, controlling building and car park access for couriers, tradespersons and visitors, round the clock security monitoring, centralised facilities bookings, controlling move in/outs, instant SMS communication with occupants and owners, and manages Airbnb and short-stay rentals.

The disclosed centralised facility management system may monitor facilities such as, buildings 24/7 in real-time from a centralised location like a Network Operations Security Centre (NOSC) via strategically placed CCTV at the building and a touch screen kiosk at the centralised location. The centralised facility management system is a technological convergence to create a valuable service that offers all the benefits of an on-site 24-hour concierge at a fraction of the cost. The centralised facility management system can monitor any building anywhere in the world.

The disclosed centralised facility management system includes an on-site touch screen kiosk for providing a direct visual access to a concierge user. The centralised facility management system and the concierge user provides support for building services and building access as well as supervision of Airbnb guests based on real-time feed from the imaging devices installed at the facility and information stored in the centralised facility management system.

The disclosed centralised facility management system may be used for managing facilities such as, but not limited to, buildings, gated communities, strata, hospitals, community centres, commercial estates, offices, retirement living homes, and so forth.

The disclosed centralised facility management system may be used for strata management, property management, building management, contractor management, and so forth. Further, the centralised facility management system may be used for security management in the buildings, facilities, residential areas, gated communities, strata, hospitals, community centres, commercial estates, offices, retirement living homes, and so forth.

The disclosed centralised facility management system may enable the users like a tenant or the property (apartment or home) owner to pay their strata fees or part of those fees by providing voice commands and also enable the user to ask questions about their fees or other aspects of the property or building and receive a response such as a voice response, an email response, a text response, and so forth. The centralised facility management system may use an AI functionality for processing payment. In some embodiments, centralised facility management system is configured to automate the payment by using automation of accounts of the users. In some embodiments, the centralised facility management system may use block chain techniques to automate accounts, and automatically pay suppliers and interact with strata or facility/building/property accounting software. In some embodiments, the users may set instructions for auto debit of one or more fees from their account via the payment module.

In some embodiments, the disclosed centralised facility management system is present in a cloud network. In alternative embodiments, one or more modules (or devices) of the centralised facility management system are present in a cloud network.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

What is claimed is:

1. A centralised facility management system for monitoring and managing a plurality of facilities in real-time, comprising:
an audio/visual input module configured to continuously receive a real-time audio/visual feed of the plurality of facilities from a plurality of imaging devices of the plurality of facilities, wherein the audio/visual input module comprises a touch enabled device to enable a concierge user to interact with the centralised facility management system;
based on the real-time audio/visual feed, a security module is configured to:
provide a controlled access of a plurality of doors, lockers, parking within and around the plurality of facilities to a plurality of users and vehicles based on the real-time audio/visual feed and via at least one of a voice recognition, a facial recognition, and a wireless technology comprising Bluetooth;
track an entry and exit of the plurality of users and the vehicles into and out of the plurality of facilities in real-time;
register and authenticate vehicles based on recognition of vehicle information comprising a number plate; and
record and respond to an incident comprising a security incident;
an asset managing module configured to monitor and record a performance of a plurality of assets of each the plurality of facilities in real-time;
a request and booking module configured to enable the plurality of users and other users to raise one or more maintenance requests and booking requests for one or more services and a unit of the plurality of facilities;
a pre-settlement module configured to enable a plurality of facility developers to post progress reports, settlement information, owners corporation information comprising move-in rules, and inductions;
an information display module configured to display information on a display device installed at each of the plurality of facilities; and
a communication module configured to automatically send at least one of a communication message and a recorded information to at least one of a plurality of stakeholders and the plurality of users based on the recorded incident, the one or more maintenance requests, the booking requests, the displayed information, and one or more events.

2. The centralised facility management system of claim 1, wherein the one or more imaging devices are placed in strategic locations in and around respective facility of the plurality of facilities, wherein the one or more imaging devices are configured to continuously provide the real-time audio/visual feed of the respective facility to the audio/visual input module.

3. The centralised facility management system of claim 1, wherein the plurality of stakeholders comprises a plurality of occupants, strata managers, managing agents, investors, facility managers, administrators, owners, facility developers, tradespersons, banks, property valuers, and purchasers, and security officials.

4. The centralised facility management system of claim 3, wherein:
the communication module is further configured to send at least one of a message and a recorded information to a security official when the security incident is recorded, wherein the communication module communicates with the plurality of stakeholders and the plurality of users in a preferred communication mode set by the plurality of stakeholders and the plurality of users, respectively; and
the pre-settlement module is further configured to enable entering of the final inspection details and tracking defect reporting for pre-settlement inspections by the facility developers, banks, property valuers, and purchasers.

5. The centralised facility management system of claim 3 further comprising a storage module configured to store and maintain facility information, rules, procedures, information of the plurality of stakeholders, information of the plurality of users, booking information, a plurality of maintenance records, the booking requests, the maintenance requests, asset information, security officials' information, a plurality of facility/building plans, asset locations, ongoing maintenance/construction work information, activities information, the information about facilities' issues, and the audio/visual feed of the plurality of facilities.

6. The centralised facility management system of claim 3 further comprising a data analysing module configured to:
analyse data comprising at least one of visitors' data, facilities' data, vehicles' data, and people profiles' data; and
take at least one action and learn based on the analysis.

7. The centralised facility management system of claim 3, wherein:
the one or more events comprising at least one of a maintenance issue with an asset, an incident, a security incident, a meeting, a delivery person or parcel arrival, a guest arrival, an inspection time, a celebration, a resident event, a facility/building work, and a community event;
the displayed information comprising at least one of activities' information, announcements, information about works being carried out in the respective facility, owners' corporation meetings' information, book reading reviews, swimming classes information, gym classes information, resident events information, weather report, yoga classes' information, celebrations information, facility/building works' information, advertisements, and promotional events information; and
communication message comprises an urgent alert concerning facility operations, facility/building works notification, a parcel delivery notification, a booking message, a meeting notification, a celebration notification, an inspection notification, an announcement, an upcoming event, an inspection, and a promotional event notification.

8. The centralised facility management system of claim 3, wherein the plurality of stakeholders, the plurality of users, and the concierge user accesses the centralised facility management system via at least one of a user interface and a uniform resource locator on a browsing application on an associated computing device.

9. The centralised facility management system of claim 1 further comprising at least one robot installed in each of the plurality of facilities, wherein the robot is configured to assist with checking in guests.

10. The centralised facility management system of claim 1 further comprising:
a payment module configured to process and automate a plurality of payments; and
a voice processing module in communication with the payment module configured to enable the plurality of users and the plurality of stakeholders to:
provide at least one voice command for making one or more payments, wherein the payment module processes the one or more payments based on the at least one voice command; and
ask one or more questions related to at least one of the plurality of facilities and the one or more payments via one or more voice questions.

11. A method for managing a plurality of monitoring and managing a plurality of facilities in real-time, comprising:
continuously receiving, by an audio/visual input module, a real-time audio/visual feed of the plurality of facilities from a plurality of imaging devices of the plurality of facilities, wherein the audio/visual input module comprises a touch enabled device to enable a concierge user to interact with the centralised facility management system;
providing, by a security module, a controlled access of a plurality of doors, lockers, parking within and around the plurality of facilities to a plurality of users and vehicles based on the real-time audio/visual feed and via at least one of a voice recognition, a facial recognition, and a wireless technology comprising Bluetooth;
registering and authenticating, by the security module, the vehicles based on recognition of vehicle information comprising a number plate of the vehicles;
tracking, by the security module, an entry and exit of the plurality of users and the vehicles into and out of the plurality of facilities in real-time;
recording and responding, by the security module, to an incident comprising a security incident;
monitoring and recording, by an asset managing module, a performance of a plurality of assets of the plurality of facilities in real-time;
enabling, by a request and booking module, the plurality of users and other users to raise one or more maintenance requests and booking requests for one or more services and a unit of the plurality of facilities;
enabling, by a pre-settlement module, a plurality of facility developers to post progress reports, settlement information, owners corporation information comprising move-in rules, and inductions;
displaying, by an information display module, information on a display device installed at each of the plurality of facilities; and
automatically sending, by a communication module, at least one of a communication message and recorded information to at least one of a plurality of stakeholders and the plurality of users based on the recorded incident, the one or more maintenance requests, the booking requests, the displayed information, and one or more events.

12. The method of claim 11, wherein:
the one or more imaging devices are placed in strategic locations in and around respective facility of the plurality of facilities, wherein the one or more imaging devices are configured to continuously provide the real-time audio/visual feed of the respective facility to the audio/visual input module; and
the plurality of stakeholders comprises a plurality of occupants, strata managers, managing agents, investors, facility managers, administrators, owners, facility developers, tradespersons, banks, property valuers, and purchasers, and security officials.

13. The method of claim 12 further comprising:
sending, by the communication module, at least one of a message and a recorded information to a security official when the security incident is recorded;
enabling, by the pre-settlement module entering of the final inspection details and tracking defect reporting so as to make pre-settlement inspections easy for the facility developers, banks, property valuers, and purchasers; and
storing and maintaining, in a storage module, facility information, rules, procedures, information of the plurality of stakeholders, information of the plurality of users, booking information, a plurality of maintenance records, the booking requests, the maintenance requests, asset information, security officials' information, a plurality of facility/building plans, asset locations, ongoing maintenance/construction work information, the information about facilities' issues, and the audio/visual feed of the plurality of facilities.

14. The method of claim 12, wherein:
the one or more events comprising at least one of a maintenance issue with an asset, an incident, a security incident, a meeting, a delivery person or parcel arrival, a guest arrival, an inspection time, a celebration, a resident event, a facility/building work, and a community event;
the displayed information comprising at least one of activities' information, announcements, information about works being carried out in the respective facility, owners' corporation meetings' information, book reading reviews, swimming classes information, gym classes information, resident events information, weather report, yoga classes' information, celebrations information, facility/building works' information, advertisements, and promotional events information;
the communication message comprising an urgent alert concerning facility operations, facility/building works notification, a parcel delivery notification, a booking message, a meeting notification, a celebration notification, an inspection notification, an announcement, an upcoming event, an inspection, and a promotional event notification; and
the wireless technology further comprises at least one of a Wi-fi, a near field communication (NFC), and cellular.

15. The method of claim 12, wherein the one or more services comprises a laundry service, a cleaning service, a pet grooming and walking service, a maintenance service, a vehicle washing/detailing, and a smoke detector servicing.

16. The method of claim 12 further comprising accessing the centralised facility management system by the plurality of stakeholders, the users, and the concierge user via at least one of a user interface and a uniform resource locator on a browsing application on an associated computing device.

17. The method of claim 12 further comprising:
analysing, by a data analysing module, data comprising at least one of visitors' data, facilities' data, vehicles' data, and people profiles' data; and
taking, by the data analysing module, at least one action and learning based on the analysis.

18. The method of claim 12 further comprising:
processing and automating, by a payment module, a plurality of payments;
enabling, by a voice processing module, the plurality of users and the plurality of stakeholders to:
provide at least one voice command for making one or more payments, wherein the payment module processes the one or more payments based on the at least one voice command; and
ask one or more questions related to at least one of the plurality of facilities and the one or more payments via one or more voice questions.

19. A centralised facility management system for monitoring and managing a plurality of facilities in real-time, comprising:
an audio/visual input module configured to continuously receive a real-time audio/visual feed of the plurality of facilities from a plurality of imaging devices of the plurality of facilities, wherein the audio/visual input module comprises a touch enabled device to enable a concierge user to interact with the centralised facility management system;
based on the real-time audio/visual feed, a security module configured to automatically:
provide a controlled access of a plurality of doors, lockers, parking within and around the plurality of facilities to a plurality of users and vehicles based on an authentication via at least one of a voice recognition, a facial recognition, and a wireless technology comprising at least one of the Bluetooth, a Wi-fi, a near field communication (NFC), cellular, and a remote Bluetooth activation;
track an entry and exit of the plurality of users and the vehicles into and out of the plurality of facilities in real-time;
register and authenticate vehicles based on recognition of vehicle information comprising a number plate of the vehicles; and
record and respond to an incident comprising a security incident;
an asset managing module configured to automatically monitor and record a performance of a plurality of assets of the plurality of facilities in real-time;
a request and booking module configured to enable the plurality of users and other users to raise maintenance requests and booking requests for one or more services and an area of the plurality of facilities;
a pre-settlement module configured to enable a plurality of facility developers to post progress reports, settlement information, owners corporation information comprising move-in rules, and inductions;
an information display module configured to display information on a display device installed at one or more of the plurality of facilities;
a communication module configured to automatically send at least one of a communication message and recorded information to a plurality of stakeholders and the plurality of users based on the recorded incident, the maintenance requests, the booking requests, the displayed information, and one or more events comprising at least one of a maintenance issue with an asset, an incident, a security incident, a meeting, a delivery person or parcel arrival, a guest arrival, an inspection time, a celebration, a resident event, a facility/building work, and a community event;
a storage module configured to store and maintain a central repository comprising facility information, rules, procedures, information of the plurality of stakeholders and the plurality of users, booking information, a plurality of maintenance records, the booking requests, the maintenance requests, asset information, a plurality of facility/building plans, asset locations, ongoing maintenance/construction work information, the information about facilities' issues, and the audio/visual feed of the plurality of facilities;
a data analysing module configured to analyse data comprising at least one of visitors' data, facilities' data, vehicles' data, and people profiles' data;
a payment module configured to process and automate a plurality of payments; and
a voice processing module in communication with the payment module configured to enable the plurality of users and the plurality of stakeholders to:
provide at least one voice command for making one or more payments, wherein the payment module processes the one or more payments based on the at least one voice command; and
ask one or more questions related to at least one of the plurality of facilities and the one or more payments via one or more voice questions.

20. The centralised facility management system of claim 19, wherein:
the plurality of imaging devices is placed in strategic locations in and around respective facility of the plurality of facilities, wherein the one or more imaging devices are configured to continuously provide the real-time audio/visual feed of the respective facility to the audio/visual input module;
the plurality of stakeholders, the plurality of users, and the concierge user accesses the centralised facility management system via at least one of a user interface and a uniform resource locator on a browsing application on an associated computing device.
